(19) United States
(12) Patent Application Publication
(10) Pub. No.: US 2025/0065813 A1
(43) Pub. Date: Feb. 27, 2025

(54) CARRYING RACK AUXILIARY DEVICE AND CARRYING RACK INCLUDING THE SAME

(71) Applicant: YOTTA INNOVATION CO., LTD., APIA (WS)

(72) Inventor: STELLA HUANG, Taipei City (TW)

(21) Appl. No.: 18/453,063

(22) Filed: Aug. 21, 2023

(51) Int. Cl. B60R 9/10

(52) U.S. Cl. CPC B60R 9/10

(57) ABSTRACT

A carrying rack auxiliary device and a carrying rack including the same are provided. The carrying rack auxiliary device is configured to be mounted on the carrying rack and located between two of wheel supports of the carrying rack. The carrying rack auxiliary device includes: a supporting portion; and at least one saddle portion connected to the supporting portion and saddled on the carrying rack so that the supporting portion extends laterally between the two wheel supports. As such, additional support is provided between the two wheel supports so that the wheels of a vehicle can easily move across a space between the two wheel supports.

### BACKGROUND OF THE INVENTION

### Field of the Invention

The present invention relates to a carrying rack auxiliary device and a carrying rack including the same.

### Description of the Prior Art

A carrying rack can be used to carry at least one vehicle such as a bicycle, electric bicycle and electric scooter. In use, the user has to move and push the vehicle to load on or unload from the carrying rack.

The conventional carrying rack includes a frame for carrying the vehicle, and the frame may be provided with a restraint mechanism, such as a belt, a fastener, a clamp or a limitation arm, to secure the vehicle on the frame. During transportation of the vehicle, two wheel supports of the carrying rack are used to support and restrain two wheels of the vehicle to stably and reliably carry the vehicle.

However, there is a large distance between the two wheel supports of the conventional carrying rack. When pushing the vehicle forward, the wheel of the vehicle will be so stuck in the large distance, and the user must exert great effort to lift and forward the vehicle, which is extremely inconvenient, time-consuming and labor-intensive to move the two wheels to the corresponding wheel support (especially for heavy electric vehicles). In addition, the conventional carrying rack does not have any side mechanism for blocking and limiting the frame or the wheel of the vehicle, and thus the vehicle may disengage from the carrying rack due to shaking and/or jolting of the vehicle.

The present invention is, therefore, arisen to obviate or at least mitigate the above-mentioned disadvantages.

### SUMMARY OF THE INVENTION

The main object of the present invention is to provide a carrying rack auxiliary device and a carrying rack including the same, in which the wheel of a vehicle can move across the space between two wheel supports of the carrying rack.

To achieve the above and other objects, a carrying rack auxiliary device configured to be mounted on a carrying rack and located between two of a plurality of wheel supports of the carrying rack is provided, wherein the carrying rack auxiliary device includes: a supporting portion; and at least one saddle portion connected to the supporting portion and saddled on the carrying rack so that the supporting portion extends laterally between the two wheel supports.

To achieve the above and other objects, a carrying rack including the carrying rack auxiliary device is provided, wherein the carrying rack further includes: a base frame configured to be connected to a vehicle, wherein the at least one saddle portion is saddled on the base frame; and the plurality of wheel supports separately connected to the base frame.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a carrying rack and a carrying rack auxiliary device according to an exemplary embodiment of the present invention;

FIG. 2 is another stereogram of a carrying rack and a carrying rack auxiliary device according to an exemplary embodiment of the present invention;

FIG. 3 is a partial cross-sectional of view FIG. 1;

FIG. 4 is a partial breakdown drawing of the carrying rack auxiliary device of an exemplary embodiment of the present invention;

FIG. 5 is another partial breakdown drawing of the carrying rack auxiliary device of an exemplary embodiment of the present invention;

FIGS. 6 and 7 are drawings showing application of the carrying rack and the carrying rack auxiliary device according to an exemplary embodiment of the present invention; and

FIGS. 8-10 are drawings showing a carrying rack and a carrying rack auxiliary device according to another exemplary embodiment of the present invention.

### DETAILED DESCRIPTION OF THE PREFERRED EMBODIMENTS

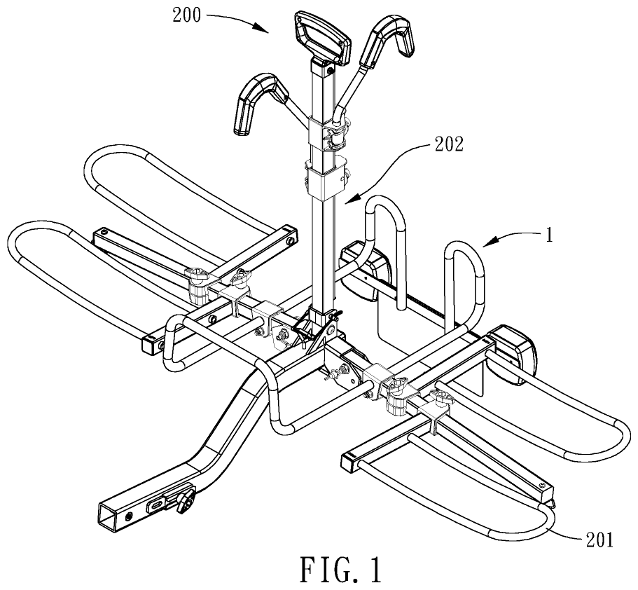

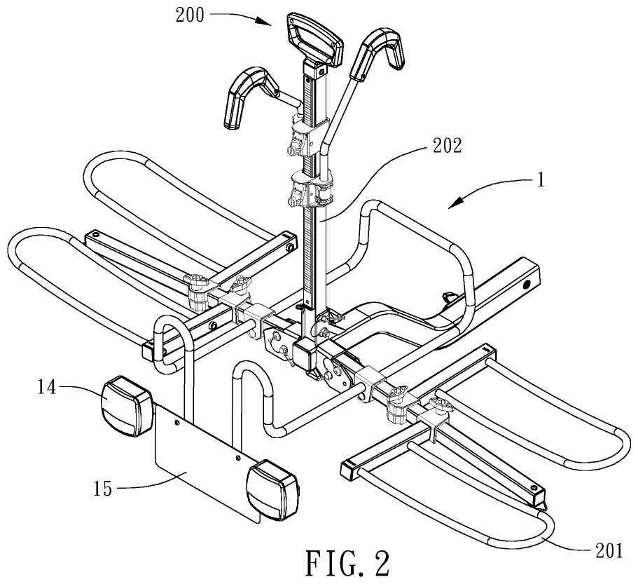

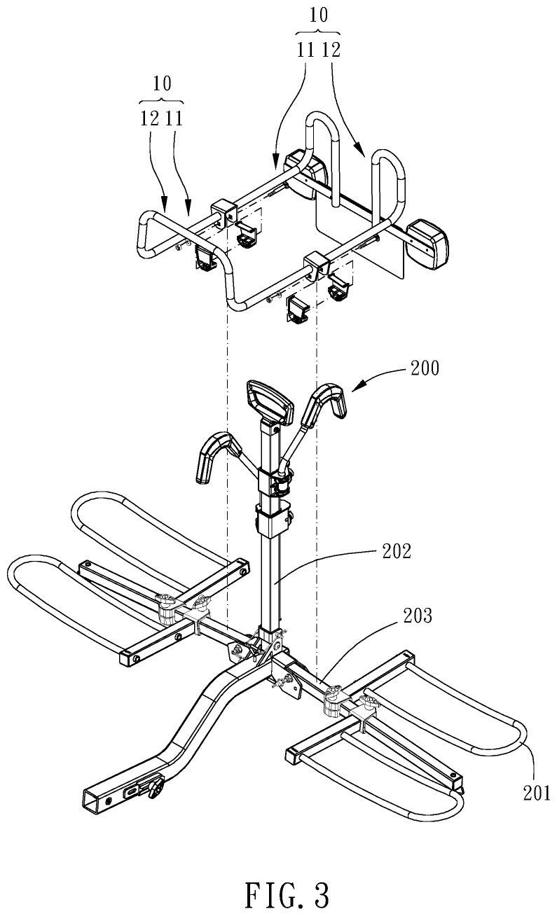

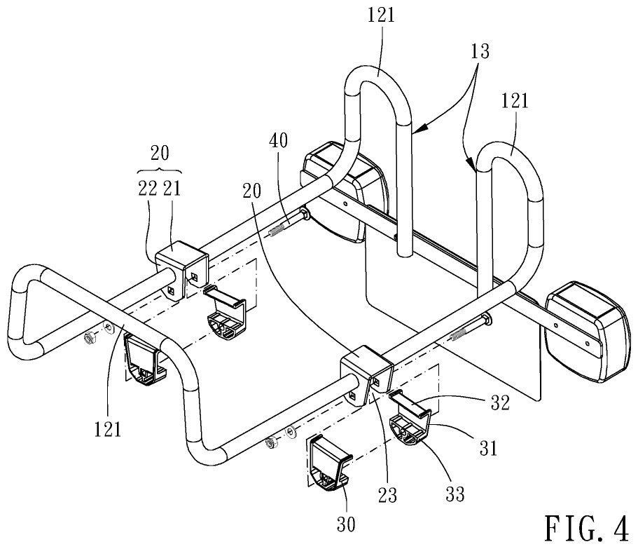

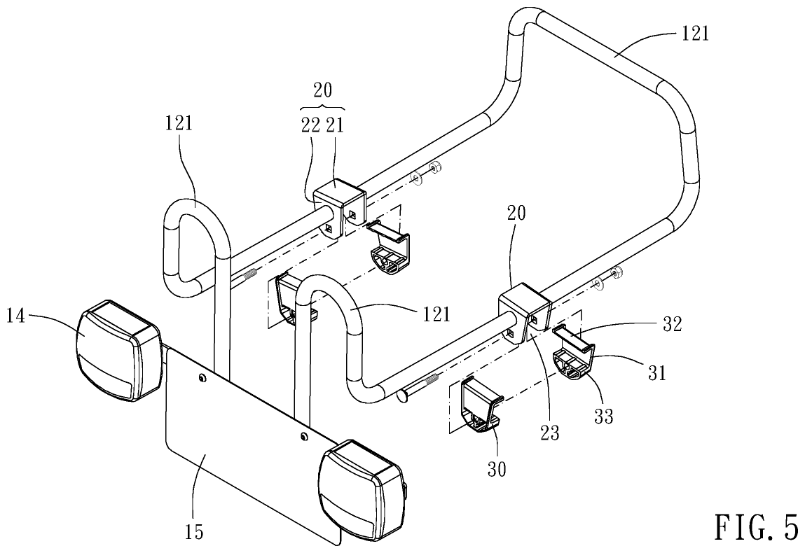

Please refer to FIGS. 1 to 7 for an exemplary embodiment of the present invention. A carrying rack auxiliary device 1 of the present invention is configured to be mounted on a carrying rack 200 and located between two of a plurality of wheel supports 201 of the carrying rack 200. The invention further provides a carrying rack 200 including the carrying rack auxiliary device 1, and further includes a base frame 202 and the plurality of wheel supports 201. The plurality of wheel supports 201 are separately connected to the base frame 202. Each two of the plurality of wheel supports 201 are configured to support and restrain front and rear wheels 301 of a vehicle 300.

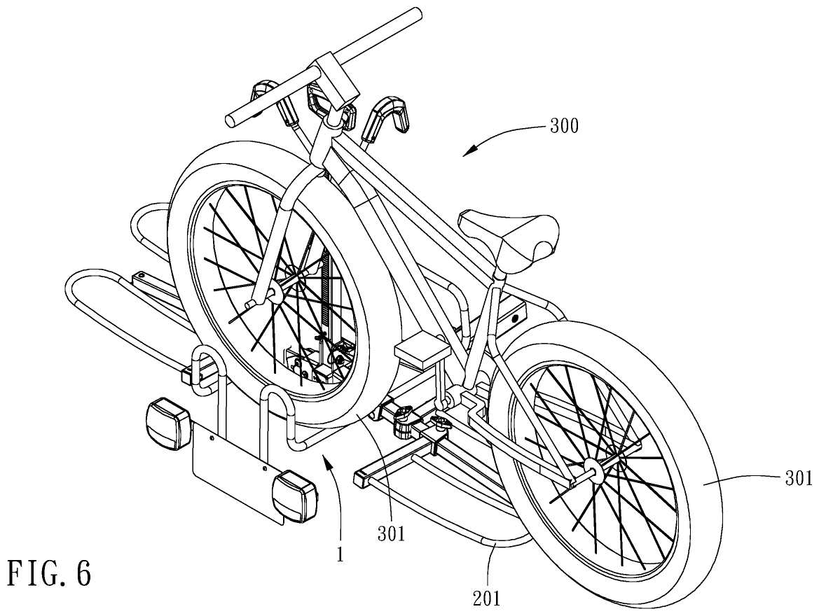

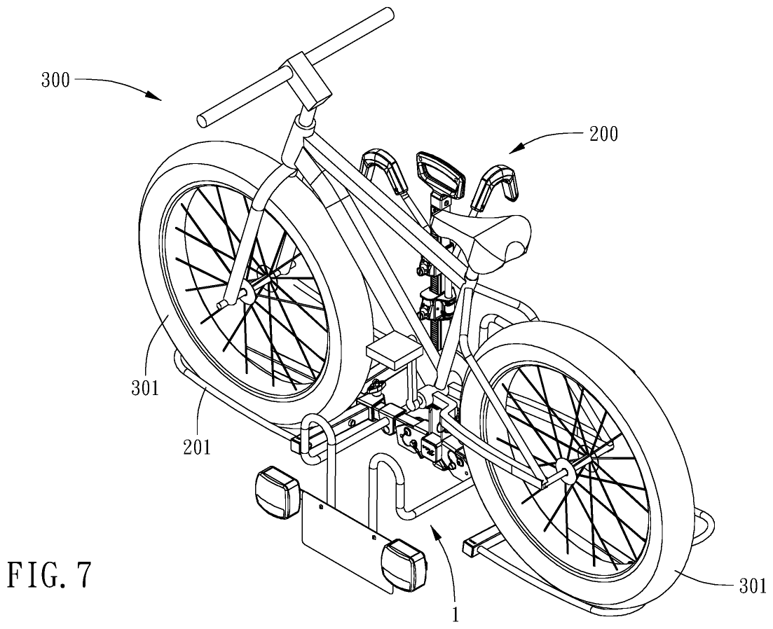

The carrying rack auxiliary device 1 includes a supporting portion 10 and at least one saddle portion 20. The at least one saddle portion 20 is saddled on the base frame 202. The at least one saddle portion 20 is connected to the supporting portion 10 and saddled on the carrying rack 200 so that the supporting portion 10 extends laterally between the two wheel supports 201. As such, the carrying rack auxiliary device 1 is easy and quick to mount and provide an additional support so that the wheel 301 of the vehicle 300 can move across the space between the two wheel supports 201 of the carrying rack 200, which can quickly and stably guide the vehicle 300 to move to the two wheel supports 201 (FIGS. 6 and 7).

The supporting portion 10 extends from at least one side of the at least one saddle portion 20. Specifically, the supporting portion 10 includes at least one lateral portion 11 extending from the at least one saddle portion 20 and at least one upright portion 12 connected to the at least one lateral portion 11, and the at least one upright portion 12 is remote from and higher than the at least one saddle portion 20. The at least one lateral portion 11 extends transversely between the two wheel supports 201 to provides an intermedia support so that the wheel 301 of the vehicle 300 has to move across a smaller space to the wheel support 201, which is labor-saving and quick. The at least one upright portion 12 provides good lateral support for supporting the frame and the wheel 301 of the vehicle 300, which effectively prevents disengagement of the vehicle 300 from the carrying rack.

Specifically, the supporting portion 10 further includes at least one supporting frame 13, the at least one saddle portion includes a plurality of saddle portions 20, and each of the at least one supporting frame 13 is connected to sides of the plurality of saddle portions 20 facing toward a same direction. The plurality of saddle portions 20 make the carrying rack auxiliary device 1 be stably held. In this embodiment, the supporting portion 10 extends from opposing sides of the at least one saddle portion 20, for carrying a plurality of vehicle; the at least one upright portion 12 includes a plurality of U-shaped frames 121, and the number and size of a portion of the plurality of U-shaped frames 121 at one of the opposing sides of the at least one saddle portion 20 are different from the number and size of a portion of the plurality of U-shaped frames 121 at the other of the opposing sides of the at least one saddle portion 20 so that it can be applied to various types of vehicles and provide good lateral support.

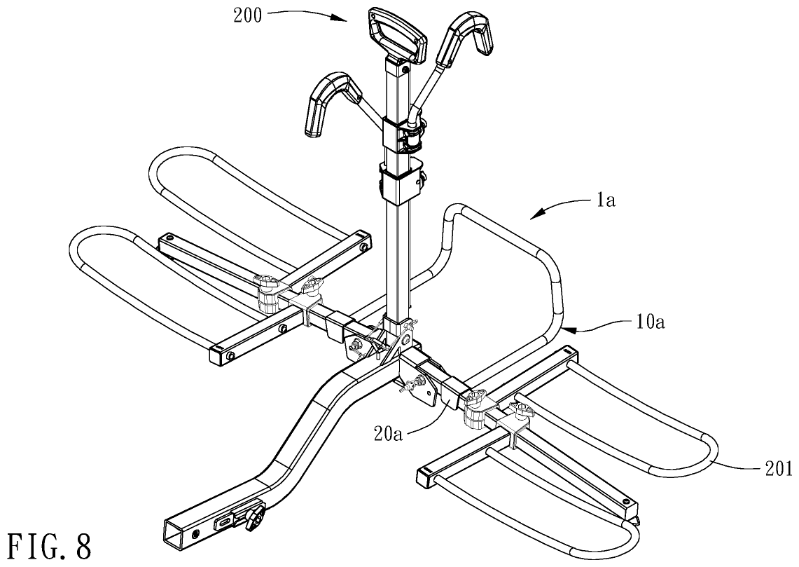

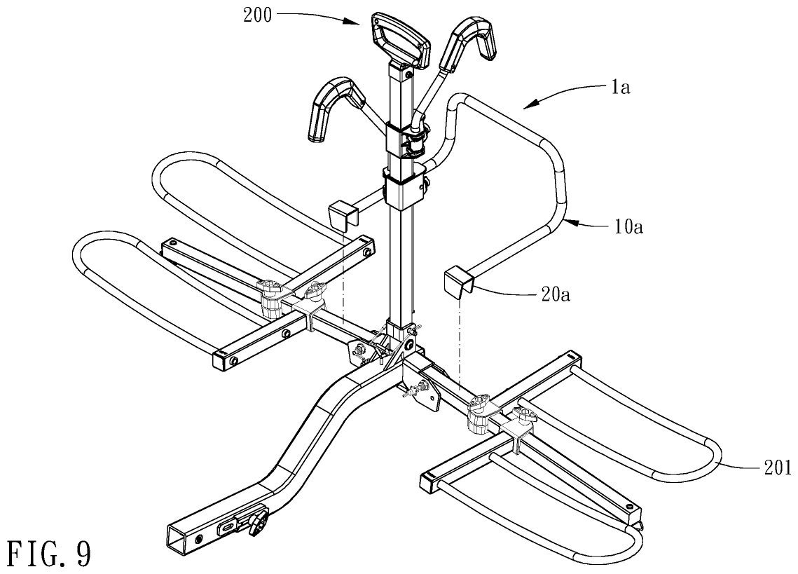

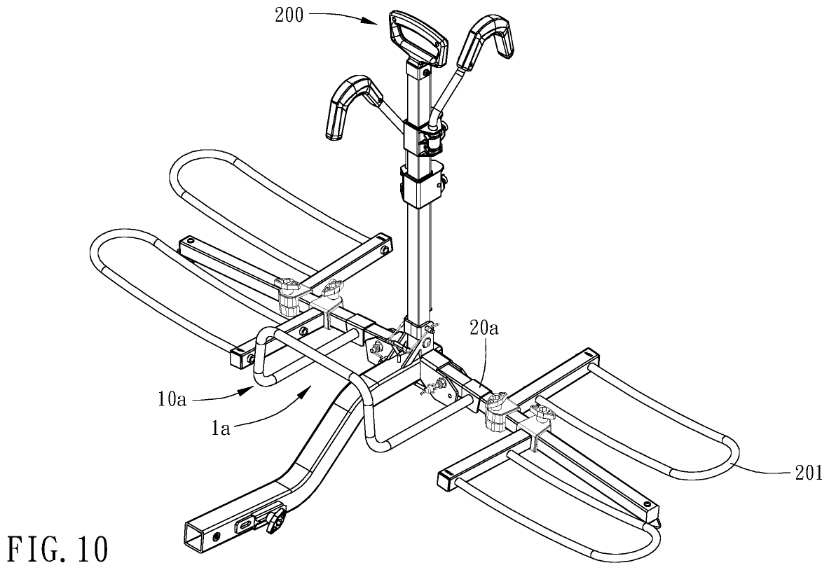

Preferably, at least one warning member 14 and at least one information board 15 are connected to the supporting portion 10. The at least one warning member 14 and the at least one information board 15 may be connected to at least one of the plurality of U-shaped frames 121. The at least one warning member 14 may be a luminous or reflective lamp, or other warning device. The at least one information board 15 may be provided with the license plate number, warning letters, precautions, or other text or patterns. In other embodiments, the supporting portion 10a may extend from a side of the at least one saddle portion 20a, and the carrying rack auxiliary device 1a can be easily and quickly interchanged to extend in an opposing direction (FIGS. 8-10).

Specifically, each of the at least one saddle portion 20 includes an abutting wall 21 and two side walls 22 separately extending from two sides of the abutting wall 21, the abutting wall 21 is configured to be abutted against a rod member 203 of the carrying rack 200, and the two side walls 22 are configured to be abutted laterally against two sides of the rod member 203 so that the carrying rack auxiliary device 1 can be mounted on the carrying rack 200 stably.

Preferably, at least one padding member 30 is received in each of the at least one saddle portion 20, and the at least one padding member 30 is configured to be disposed between the at least one saddle portion 20 and the carrying rack 200. Each of the at least one padding member 30 is configured to receive the rod member 203 of the carrying rack 200. At least one fastener 40 is disposed through and connects the at least one saddle portion 20 and the at least one padding member 30, and the at least one fastener 40, the at least one padding member 30 and the at least one saddle portion 20 are disposed around and stably secure the rod member 203 of the carrying rack 200.

Each of the at least one padding member 30 includes an upright wall 31, a blocking flange 32 extending transversely from an end of the upright wall 31, and a bulk 33 extending transversely from another end of the upright wall 31 and corresponding to the blocking flange 32. The upright wall 31 and the blocking flange 32 are abutted against an inner surface of the at least one saddle portion 20, and the bulk 33 extends within a saddle slot 23 of the at least one saddle portion 20. Preferably, each of the at least one saddle portion 20 receives two padding members 30 clamping the rod member 203 of the carrying rack 200, which has good combination, stability, cushioning and shock absorption.

Although particular embodiments of the invention have been described in detail for purposes of illustration, various modifications and enhancements May be made without departing from the spirit and scope of the invention. Accordingly, the invention is not to be limited except as by the appended claims.

What is claimed is:

1. A carrying rack auxiliary device configured to be mounted on a carrying rack and located between two of a plurality of wheel supports of the carrying rack, the carrying rack auxiliary device including:
a supporting portion; and
at least one saddle portion connected to the supporting portion and saddled on the carrying rack so that the supporting portion extends laterally between the two wheel supports.

2. The carrying rack auxiliary device of claim 1, wherein the supporting portion extends from at least one side of the at least one saddle portion.

3. The carrying rack auxiliary device of claim 2, wherein the supporting portion includes at least one lateral portion extending from the at least one saddle portion and at least one upright portion connected to the at least one lateral portion, and the at least one upright portion is remote from and higher than the at least one saddle portion.

4. The carrying rack auxiliary device of claim 1, wherein each of the at least one saddle portion includes an abutting wall and two side walls separately extending from two sides of the abutting wall, the abutting wall is configured to be abutted against a rod member of the carrying rack, and the two side walls are configured to be abutted laterally against two sides of the rod member, respectively.

5. The carrying rack auxiliary device of claim 1, wherein at least one padding member is received in each of the at least one saddle portion, and the at least one padding member is configured to be disposed between the at least one saddle portion and the carrying rack.

6. The carrying rack auxiliary device of claim 5, wherein at least one fastener is disposed through and connects the at least one saddle portion and the at least one padding member.

7. The carrying rack auxiliary device of claim 5, wherein each of the at least one padding member includes an upright wall, a blocking flange extending transversely from an end of the upright wall, and a bulk extending transversely from another end of the upright wall and corresponding to the blocking flange, the upright wall and the blocking flange are abutted against an inner surface of the at least one saddle portion, the bulk extends within a saddle slot of the at least one saddle portion, and each of the at least one padding member is configured to receive a rod member of the carrying rack.

8. The carrying rack auxiliary device of claim 3, wherein the supporting portion extends from opposing sides of the at least one saddle portion; the at least one upright portion includes a plurality of U-shaped frames, and the number and size of a portion of the plurality of U-shaped frames at one of the opposing sides of the at least one saddle portion are different from the number and size of a portion of the plurality of U-shaped frames at the other of the opposing sides of the at least one saddle portion; each of the at least one saddle portion includes an abutting wall and two side walls separately extending from two sides of the abutting wall, the abutting wall is configured to be abutted against a rod member of the carrying rack, and the two side walls are configured to be abutted laterally against two sides of the rod member, respectively; at least one padding member is received in each of the at least one saddle portion, and the at least one padding member is configured to be disposed between the at least one saddle portion and the carrying rack; at least one fastener is disposed through and connects the at least one saddle portion and the at least one padding member; each of the at least one padding member includes an upright wall, a blocking flange extending transversely from an end of the upright wall, and a bulk extending transversely from another end of the upright wall and corresponding to the blocking flange, the upright wall and the blocking flange are abutted against an inner surface of the at least one saddle portion, the bulk extends within a saddle slot of the at least one saddle portion, and each of the at least one padding member is configured to receive a rod member of the carrying rack; at least one warning member and at least one information board are connected to the supporting portion.

9. The carrying rack auxiliary device of claim 1, wherein the supporting portion includes at least one supporting frame, the at least one saddle portion includes a plurality of saddle portions, and each of the at least one supporting frame is connected to sides of the plurality of saddle portions facing toward a same direction.

10. A carrying rack including the carrying rack auxiliary device of claim 1 and further including:
a base frame configured to be connected to a vehicle, wherein the at least one saddle portion is saddled on the base frame; and
the plurality of wheel supports separately connected to the base frame.
